(19) United States
(12) Patent Application Publication
(10) Pub. No.: US 2009/0022215 A1
(43) Pub. Date: Jan. 22, 2009

(54) MODEM

(75) Inventors: Jilin Li, Shenzhen (CN); Guzheng Wu, Shenzhen (CN); Guifu Xie, Shenzhen (CN); Dong Wei, Shenzhen (CN)

Correspondence Address: DARBY & DARBY P.C., P.O. BOX 770, Church Street Station, New York, NY, 10008-0770, US

(73) Assignee: Huawei Technologies Co., Ltd., Shenzhen (CN)

(21) Appl. No.: 12/176,563

(22) Filed: Jul. 21, 2008

(30) Foreign Application Priority Data
Jul. 20, 2007 (CN) 200720155080.3

(51) Int. Cl. H04B 1/38

(52) U.S. Cl. 375/222

(57) ABSTRACT

A modem includes a modulation/demodulation function module, a hub function module, and at least one storage module. The storage module and the modulation/demodulation function module are connected to the hub function module, respectively. By adding one or more storage modules in to the modem, the invention enables mass storage of data to be provided at the modem, and thereby provides convenience to the user.

### CROSS-REFERENCE TO RELATED APPLICATION

This application claims priority under 35 U.S.C. § 119 from Chinese Patent Application No. 200720155080.3, filed Jul. 20, 2007, the contents of which are hereby incorporated by reference in their entirety herein.

### FIELD OF THE INVENTION

This invention relates to network communication technology, and in particular, to a modem.

### BACKGROUND OF THE INVENTION

In recent years, mobile data exchange and storage has become a hot spot in network communication technology, and various mobile storage devices have been growing profusely and quickly. Mobile storage devices have grown from Universal Serial Bus (USB) keys with a capacity barely enough to store personal information in the early stages, to removable USB hard disks with a capacity comparable to hard disks in Personal Computers (PCs), to mobile storage devices utilizing flash memory as the storage medium (such as USB flash disks and U-disks, etc.), and finally to data storage devices widely used in peripheral equipment of PCs and multimedia electric household appliances. It is obvious that the mobility and convenience of data exchange has become an essential requirement for data storage today. Mobile data exchange has driven rapid development of IT industry and brought convenience to our life.

In our life, data is often required to be moved and exchanged. As a result, USB storage devices have been widely used. The USB storage device is a physical device with a USB interface for data storage, such as the commonly seen USB flash disk and U-disk. In the prior art, access to the USB storage device is implemented by use of the physical USB interface and USB driver. In this implementation, the USB storage device is taken as a slave USB device and connected to a master USB device, such as a PC, via the physical USB interface, and the USB driver is utilized to enable the master USB device to add data to or delete data from the USB storage device, etc.

In practice, people often utilize USB wireless modems to implement wireless access to the Internet. The USB wireless modem is a physical device with a USB interface and wireless interconnection function, which can be connected to a PC via the USB interface so as to provide wireless interconnection between the PC and the network.

However, in practice, people may expect to implement wireless network access via a USB wireless modem while implementing move and storage of data via a USB storage device at the same time. In that case, the user has to connect a USB wireless modem and a USB storage device to the PC at the same time via different USB interfaces on the PC, which will undoubtedly cause significant occupation of USB interface resource in the case that there are only a limited number of USB interfaces on the PC. Furthermore, the user has to carry a USB wireless modem and a USB storage device at the same time, and perhaps even a USB hub if the USB interface resources are insufficient, which brings severe inconvenience to daily use.

### SUMMARY OF THE INVENTION

An embodiment of the invention provides a modem to overcome the drawback of waste of USB interface resource and inconvenience because the USB wireless modem and the USB storage device have to be used separately in the prior art.

To achieve the above object, the invention provides a modem, comprising a modulation/demodulation function module, a hub function module and at least a storage module. The storage module and the modulation/demodulation function module are connected to the hub function module respectively.

Compared to the prior art, by adding a storage module to the existing modem, the invention affords mass data storage capacity to the modem, saves USB interface resources and brings convenience to the user.

### BRIEF DESCRIPTION OF THE DRAWINGS

The invention will become more readily apparent from the Detailed Description of the Invention which proceeds with reference to the drawings, in which:

FIG. 1 is a schematic diagram illustrating a USB wireless modem according to an embodiment of the invention; and

FIG. 2 is a schematic diagram illustrating an application of the USB wireless modem according to an embodiment of the invention.

### DETAILED DESCRIPTION OF THE EMBODIMENTS

The invention is directed to a modem, which is afforded with mass data storage capacity by adding a storage module to the existing modem. The invention is described in detail using a USB wireless modem as example; however, the invention is not limited to being implemented as a USB wireless modem. Rather, the invention may be embodied in many other types of modems, including but not limited to Personal Computer Memory Card International Association (PCMCIA) modems and Express Card modems. Though the interfaces of those Modems are not USB interfaces, they can be mapped to USB interfaces in actual applications.

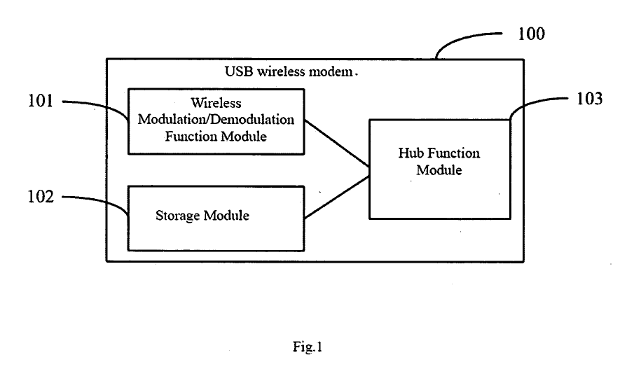

Referring to FIG. 1, a structural representation of a USB wireless modem provided in the invention is shown. The USB wireless modem 100 includes: a wireless modulation/demodulation function module 101, a storage module 102 and a hub function module 103.

The wireless modulation/demodulation function module 101 is adapted to implement functions related to wireless signal modulation/demodulation, so as to enable the user to access the wireless communication network as well as to interconnect and communicate with the wireless communication network. The storage module 102 is adapted to implement mass storage of user data. The user may access the storage module 102 via a USB interface (not shown), and may perform reading/writing, add, or delete operations for the data in the storage module 102. The storage module 102 may use a flash chip as the storage medium, which is very small in size but large in capacity, up to the storage capacity of 8 GB today. As a result, the storage module 102 with a built-in flash chip may be arranged in the USB wireless modem 100 conveniently.

It should be noted that the storage medium of the storage module 102 for mass storage may be the remaining space in a flash chip which is in the USB wireless modem 100 and adapted to store firmware, or may alternatively be one or more integral flash chips. If the storage medium of the storage module 102 is the remaining space in the flash chip which is in the USB wireless modem 100 and adapted to store firmware, the storage space of the flash chip needs to be divided. In other words, a certain storage space is provided to store the firmware of the USB wireless modem 100 and the remaining storage space is provided to implement the mass storage of data.

The wireless modulation/demodulation function module 101 and the storage module 102 are connected to the hub function module 103 via the USB interface respectively. The hub function module 103 may have a plurality of downlink interfaces. Therefore, the hub function module 103 may be connected to a plurality of storage modules 102 as required, and each of the connected storage modules 102 may be used for mass storage of the user data simultaneously. The hub function module 103 has only one uplink interface, which is adapted to connect the master USB device (for example a PC When the USB wireless modem 100 is connected to a PC via the uplink interface of the hub function module 103, the user may realize the reading/writing of data in the USB wireless modem 100 and the function of communication with the wireless network at the same time. It should be noted that, in the USB wireless modem provided in the embodiment of the invention, the wireless modulation/demodulation function module and the storage module are connected to the hub function module via the USB interface respectively, but the invention is not limited to connections via USB interface; for example, for a PCMCIA modem, the modulation/demodulation function module and the storage module in the PCMCIA modem may be connected to the hub function module via other communication interfaces (for example, a serial interface).

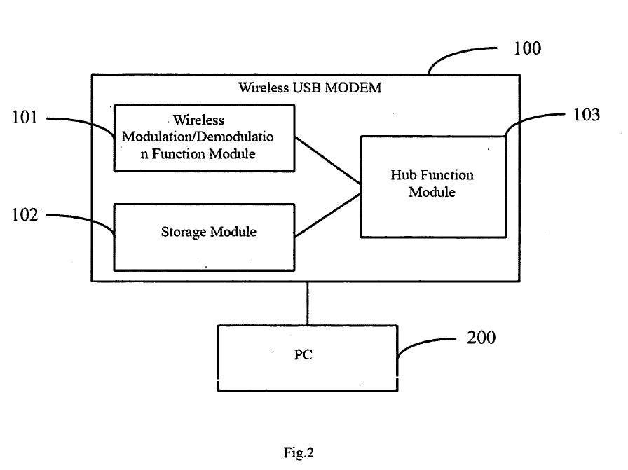

FIG. 2 is a schematic diagram of application of the USB wireless modem provided in another embodiment of the invention. The USB wireless modem 100 provided in the embodiment of the invention is connected to a PC 200 via an uplink interface of the hub function module 103. Upon connection, the USB wireless modem 100 is powered up and initialized through the PC 200. When finding more than one slave USB devices including a hub function module 103, a wireless modulation/demodulation function module 101 and a storage module 102, the PC 200 enumerates the types of the slave USB devices and loads corresponding device drivers for them, so as to activate those slave USB devices.

After the wireless modulation/demodulation function module 101 is activated through the loaded driver, the PC 200 may utilize the wireless modulation/demodulation function module 101 to communicate with the wireless network.

After the storage module 102 is activated through the loaded driver, the PC 200 may implement the read/write operation of the data in the storage module.

In the present embodiment of the invention, the wireless modulation/demodulation function module 101 and the storage module 102 are connected to the hub function module 103. While accessing the wireless network via the wireless modulation/demodulation function module 101, the PC 200 may implement various operations on the user data in the storage module 102, for example the operations of read/write, add or delete. The two processes (i.e., modulation/demodulation and storage) are independent of each other, and do not affect each other.

When the USB wireless modem 100 provided in the embodiment of the invention is connected to the PC 200, the PC 200 may thereby access the wireless network. If a user needs to download data, the PC 200 may download the data directly into the storage module 102 with data manipulation instructions, without occupation of any storage space in the PC 200, which is convenient for the user to manage the downloaded data.

The USB wireless modem 100 according to the present invention is not limited to having only one wireless modulation/demodulation function module 101 and one storage module 102. Since the hub function module 103 may have more than one USB downlink interfaces the hub function module 103 may be connected to a plurality of wireless modulation/demodulation function modules 101 and a plurality of storage modules 102 simultaneously. If a plurality of wireless modulation/demodulation function modules 101 is connected to the hub function module 103, the USB wireless modem is thereby adapted to access a plurality of wireless networks; and if multiple storage modules 102 are connected, higher user data storage capacity may be obtained.

In summary, the present invention provides a storage module that is added to a USB wireless modem. In particular, the storage module and an existing wireless modulation/demodulation module are connected to a hub function module via a USB interface. In this manner, the invention provides for mass storage of user data in the USB wireless modem, saves USB interface resources and provides convenience to the user.

While the present invention has been illustrated and described with reference to several exemplary embodiments, the present invention is not limited to these embodiments. Those skilled in the art should recognize that various variations and modifications may be made without departing from the spirit and scope of the present invention as defined by the accompanying claims. Accordingly, it is expressly intended that all such variations, changes and foreseeable equivalents which fall within the spirit and scope of the present invention as defined in the claims, be embraced thereby.

What is claimed is:

1. A modem, comprising
a modulation/demodulation function module,
a storage module, and
a hub function module connecting the storage module and the modulation/demodulation function module.

2. The modem according to claim 1, wherein the modem is a wired modem having a Universal Serial Bus interface.

3. The modem according to claim 1, wherein the modem is a wireless modem having a Universal Serial Bus interface.

4. The modem according to claim 1, wherein the hub function module comprises an uplink interface and at least two downlink interfaces; and wherein the uplink interface is adapted for connection to a PC while the downlink interfaces are adapted to be connected to the modulation/demodulation function module and the storage module, respectively.

5. The modem according to claim 4, wherein the uplink interface comprises a Universal Serial Bus interface.

6. The modem according to claims 1, wherein the storage medium of the storage module comprises a flash chip.

7. The modem according to claim 6, wherein the flash chip provides firmware storage for the modem.

8. The modem according to claim 6, wherein the storage medium comprises one or more flash chips.
